(19) United States
(12) Patent Application Publication
(10) Pub. No.: US 2011/0132946 A1
(43) Pub. Date: Jun. 9, 2011

(54) UPRIGHT BIKE MOUNT

(75) Inventors: Chris Sautter, Portland, OR (US); James Owen, Portland, OR (US); Dave Condon, Wilsonville, OR (US)

(73) Assignee: Yakima Products, Inc., Beaverton, OR (US)

(21) Appl. No.: 12/795,280

(22) Filed: Jun. 7, 2010

Related U.S. Application Data
(60) Provisional application No. 61/184,691, filed on Jun. 5, 2009.

(51) Int. Cl. B60R 9/048

(52) U.S. Cl. 224/324

(57) ABSTRACT

A bike mount has an elongate body for supporting a bike. A front end of the bike mount may include a pair of hoop structures for gripping the front wheel of a bike. One of the hoop structures may have a ramp for causing rotation of the hoop structure as a bike rolls on to the ramp. One or more clamps are included for fastening the bike mount to one or more crossbars.

### CROSS-REFERENCE TO RELATED APPLICATION

This application claims priority from U.S. Provisional Patent Application Ser. No. 61/184,691, filed Jun. 5, 2009 which is incorporated herein by reference. This application incorporates by reference the following: U.S. Publication Nos. US-2007-0164065-A1 and US-2010-0078454-A1; and U.S. Pat. Nos. 7,726,528, 6,868,998, 6,494,351 and 6,460,743.

### BACKGROUND

Bike mounts have been used for many years to transport bikes on vehicles. For example, bikes may be secured to vehicle roof tops, trunks, hatchbacks, trailers, and truck beds.

In recent years bike styles and designs have changed drastically. What used to be a single standard bike frame design was replaced with a myriad of different frame styles. The materials used to construct bike frames has also become highly varied. Frames are made of various metal alloys, steel, aluminum, titanium, and carbon fiber materials.

Bike mounts require mechanisms to securely fasten a bike to a rack. Sometimes the fastener grips the bike frame. However, a problem with gripping the frame is that the same fastener may not work adequately for certain frame geometries. Another problem is that some frame materials such as aluminum or carbon fiber may be susceptible to damage due to tight clamping forces.

In other bike mounts a fastener primarily grips the wheels of a bike. This type of fastener is advantageous because, unlike bike frame configurations, wheel dimensions tend to remain more standardized. Wheel gripping bike mounts also avoid potentially damaging gripping forces on a bike frame.

Prior wheel gripping bike mounts have had problems relating to security, ease of use, and other issues. Wheel gripping bike mounts for the top of a vehicle require a fastening mechanism that can be operated at a relatively low level since a person standing on the side of the vehicle may not be able to reach much higher than the top of the vehicle roof.

### SUMMARY

A top-of-vehicle, wheel-gripping bike mount uses a pair of pivoting hoops to grip the front wheel of a bike. The bike mount includes a front clamp for gripping a crossbar. The bike mount may also use a rear clamp for gripping a second crossbar. A binding device may be provided at the rear portion of the bike mount for gripping the rear wheel of a bike.

### BRIEF DESCRIPTION OF THE DRAWINGS

FIG. 1 is a perspective view of a bike mount on top of a vehicle.

FIG. 2 is a partial side elevation view of a bike mount, drawn in two positions, in solid and dashed lines, respectively.

FIG. 3 is a partial cross-sectional view of the bike mount shown in FIGS. 1 and 2.

FIG. 4 is a series of elevation views showing a clamp mounted on crossbars of different shapes.

FIG. 5 is a partial perspective bottom view of a bike mount.

FIG. 6 is a partial perspective elevation view of the bike mount shown in FIG. 5.

FIG. 7 is a partial perspective elevation view of a bike mount including a lock device.

FIGS. 8 and 9 are partial sectional views of a lock device for a bike mount.

FIG. 10 is a partial side view of a bike mount including an adjustment device for altering the effective hoop size to accommodate different tire dimensions.

FIG. 11 is a partial perspective elevation view of the rear portion of a bike mount.

FIG. 12 is a partial side view of a bike mount.

FIG. 13 is a partial perspective view of a bike mount, focusing on a rear clamp.

FIG. 14 is a perspective bottom view of the clamp shown in FIG. 13.

FIGS. 15 and 16 are partial perspective views of a bike mount, focusing on a rear wheel gripping device.

FIG. 17 is a partial side view of an alternative bike mount embodiment.

### DETAILED DESCRIPTION

This disclosure provides numerous selected examples of invented devices for carrying cargo on or with a vehicle. Many alternatives and modifications which may or may not be expressly mentioned, are enabled, and supported by the disclosure.

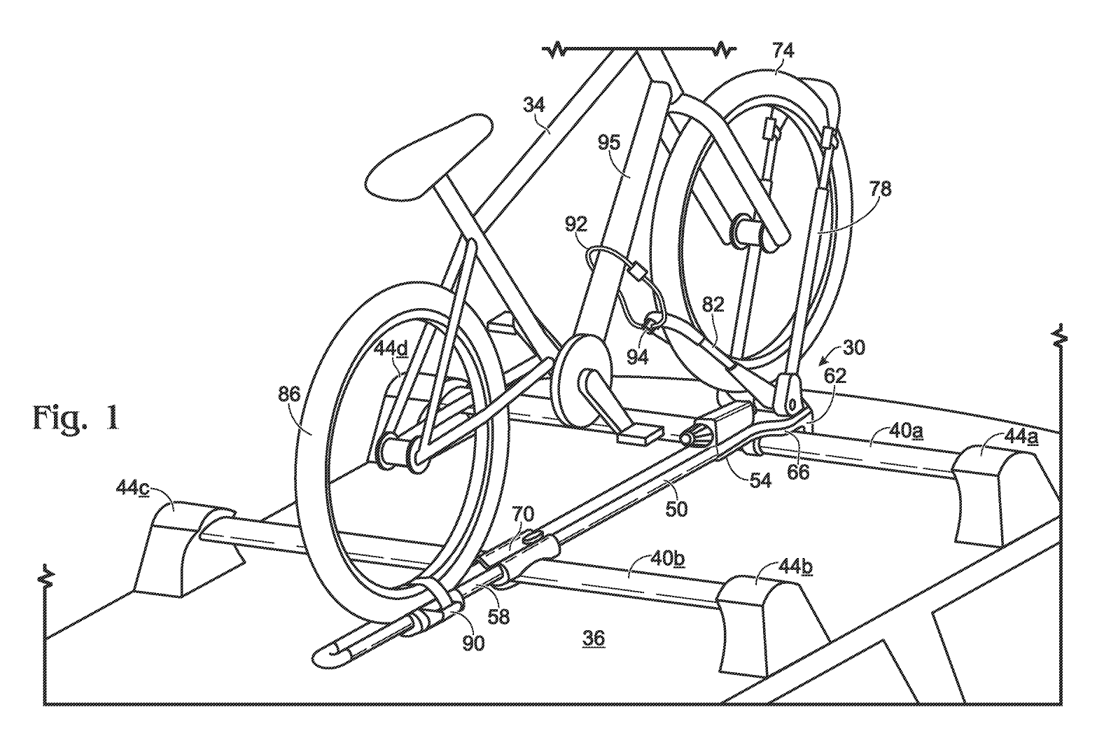

FIG. 1 shows bike mount 30 for carrying bicycle 34 on top of vehicle 36. Crossbars 40a and 40b are secured to the roof of vehicle 36 via towers 44a-d. Bike mount 30 includes elongate base 50 having front portion 54 and back or rear portion 58. Front portion 54 of base 50 includes head portion 62. Head portion 62 has clamp 66 for gripping front crossbar 40a. Rear portion 58 of body 50 has rear clamp 70 for gripping rear crossbar 40b. Front wheel 74 of bike 34 is gripped by first hoop 78 and second hoop 82. Rear wheel 86 of bicycle 34 is gripped by rear wheel binding 90. Cable lock 92 passes through ring 94 on second hoop 82 and around downtube 95 of bicycle 34 for preventing theft.

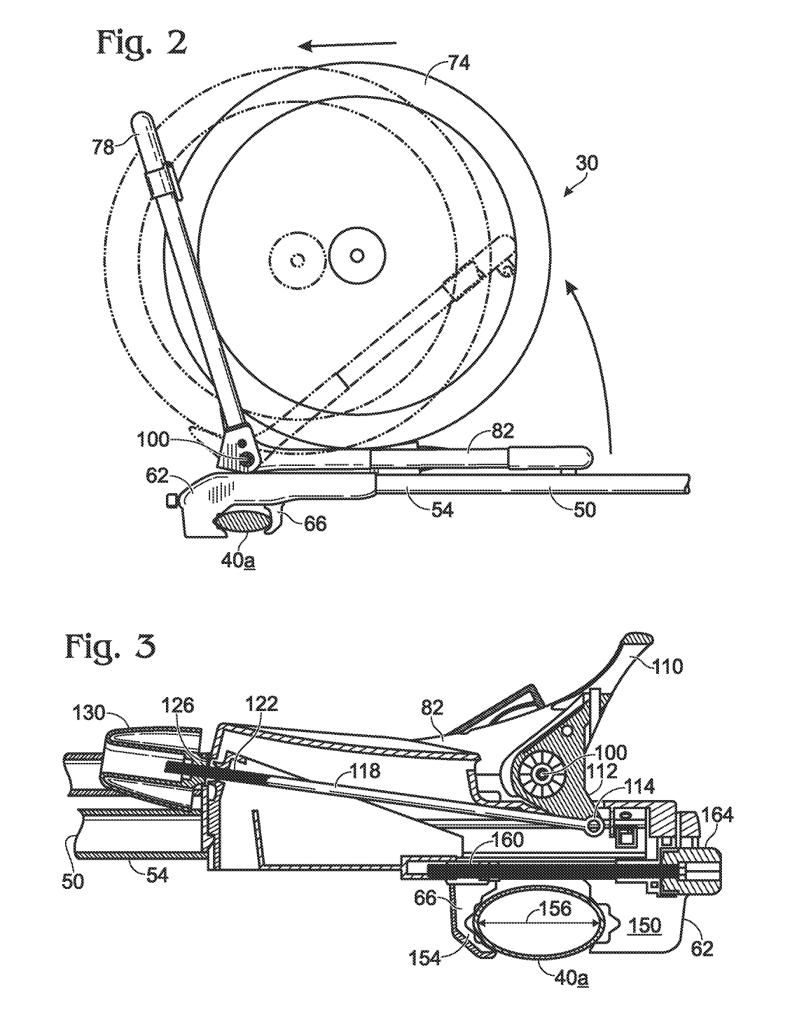

FIG. 2 shows front portion 54 of bike mount 30. Elongate body 50 includes head portion 62. The bottom side of head portion 62 has clamp 66 for gripping crossbar 40a. Bicycle wheel 74 is clamped or gripped by first hoop member 78 and second hoop member 82. First hoop member 78 and second hoop member 82 share the same pivotal axis 100 in this embodiment. However, other versions of a similar bike mount may provide different pivoting axes for each hoop member. FIG. 2 also shows forward movement of bicycle wheel 74 in dashed lines, and corresponding upward, counterclockwise rotational movement of second hoop member 82.

The first wheel hoop member rotates to a constant angle relative to the base. The first hoop member has a plastic wheel contact part near the top of the hoop which is adjustable for various wheel diameters. The rear wheel hoop member is adjustable in angle to accommodate different wheel diameters. A lock cable is attached to the top of the rear hoop (FIG. 1) and is long enough to be looped around a bicycle downtube.

As shown in FIG. 2, the front wheel of the bicycle is captured in three contact points, the top of the front hoop, the top of the rear hoop, and the bottom of the rear hoop. Once the bike has been rolled into the front hoop, causing the rear hoop to rotate upward, the bike is sufficiently stable so that the user may finish securing the mount without holding onto the bike.

FIG. 3 shows a cross-section through head 62 of elongate body 50 of bicycle mount 30. Second hoop member 82 has ramp 110 for engaging or contacting a front wheel of a bicycle as it is loaded onto rack 30. As a wheel rolls onto ramp 110, second hoop member 82 pivots upward around axis 100 to an upright or clamping position, as shown previously in FIG. 2.

Second hoop member 82 also has lever arm 112 projecting downward when second hoop member 82 is in its collapsed or stowed position. Lever arm 112 has pivot point 114. Bolt member or shaft 118 is connected to pivot point 114 of lever arm 112. The opposite end portion of 122 of bolt member 118 is threaded, and projects through opening 126 of head 62. Knob or handle 130 has a hole with internal threads for engaging threaded end portion 122 of bolt member 118. Tightening rotation of handle 130 causes lever arm 112 to rotate around axis 100 in a clockwise direction, as shown in FIG. 3. Second hoop member 82 including ramp 110 and lever arm 112 may also be referred to as a three-way rocker system for clamping a bicycle wheel. In use, it can be seen that a wheel exerting a forward force on ramp 110 causes clockwise rotational movement of lever arm 112, and corresponding movement of bolt member 118 through opening 126, thus exposing visibly threads on bolt member 118. A user may then simply spin or rotate handle 130 in a clockwise, or tightening direction until the threads are no longer visible and the second hoop member is tightened in a carriage position around a front bicycle wheel.

In operation, when the front wheel hits the ramp at the front of the rear hoop, the weight of the bike pushes the ramp down and the rear hoop rotates up against the wheel. When the rear hoop raises up, the long bolt is driven towards the rear of the bike. The knob or handle (preferably red) is attached to the long bolt and also moves rearward, exposing about two inches of threads of the long bolt between the base and the red knob. The weight of the bike keeps the front wheel in position and the front wheel rotated up which allows the user to let go of the bike. The user spins the red knob until it is seated against the base then tightens the knob. With the knob tight against the base, the long bolt is prevented from moving forward and allowing the rear hoop to rotate down and release the bike.

To release the bike, the red knob is loosened until it hits a stop formed by a locking nut at the end of a long bolt. With the knob fully loose, a gap is formed between the knob and the base exposing the long bolt. The bike is then rolled rearward which allows the rear hoop to lower and the knob to move forward to the base. When the bike is released and removed, the front hoop is folded down toward the back of the mount.

FIG. 3 also illustrates components of front clamp 66 of head 62. Head 62 includes stationary jaw 150 descending from the bottom side of head 62. Sliding jaw 154 is movable, in a reciprocating mode, back and forth in an internal track of head 62, alternately toward and away from stationary jaw 150 in the direction of arrow 156. Threaded bolt 160 extends through head 62, and engages a threaded aperture in sliding jaw 66. Handle 164 is connected to the other end of bolt 160. Rotation of handle 164 causes reciprocating motion of sliding jaw 66 in the back and forth directions of arrow 156. Handle 164 may take the form of a simple screw knob, or may use a pivoting cam lever to actuate movement of the sliding jaw. It may also be useful to use a screwing and pivoting cam lever, the screwing action for rough adjustment, and the pivoting cam action for final quick engagement and release. The direction of reciprocating motion of sliding jaw 66 may be referred to as a “horizontal” direction, which basically means it is perpendicular to the gravitational direction which is considered “vertical”. Both of the “horizontal” and “vertical” directions are considered to be linear directions in contrast to curved, or angular directions.

As shown in FIG. 3, the jaws 150 and 154 have contours on their inner surface which are configured for accommodating crossbars of different shapes and sizes. For a bike mount that straddles two crossbars, preventing rotation on a single crossbar is less important. However, accommodating different crossbar shapes and angles may be an objective.

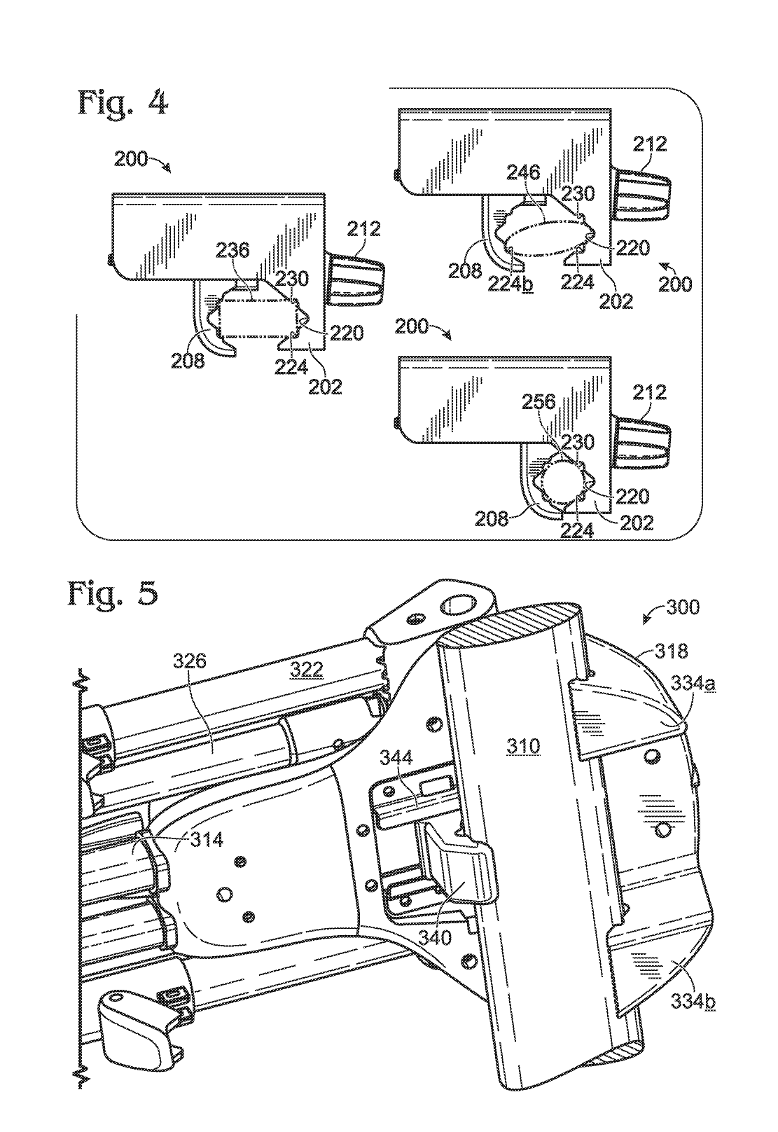

FIG. 4 shows a series of views of a bike mount clamp adapting to grip crossbars of different shapes and sizes. For example, head portion 200 includes stationary jaw 202 and sliding jaw 208. Knob 212 is provided for controlling reciprocating back and forth movement of sliding jaw 208 toward and away from stationary jaw 202. Each jaw has an internal surface with grooves, notches, and/or recesses for accommodating different crossbar shapes. Grooves on the inner surface of each jaw include center groove 220, lower groove 224, and upper groove 230. The first view in the series shows grooves 224, and 230 of jaws 202 and 208 gripping a rectangular crossbar 236. The next view (upper right) shows center groove of stationary jaw 202 and lower groove 224b of sliding jaw 208 gripping an angled, elliptically-shaped crossbar 246. The third view (lower right) shows stationary jaw 202 and sliding jaw 208 gripping round crossbar 256. Round crossbar 256 contacts the shoulders of the inner surfaces of the jaws between the grooves.

FIG. 5 shows a bottom view of bike mount 300 clamped on elliptically-shaped crossbar 310. Elongate base 314 includes head 318. First hoop member 322 and second hoop member 326 are collapsed into their stowed position substantially parallel with elongate body 314. Two stationary jaws 334a and 334b descend from the bottom side of head 318. Sliding jaw 340 moves back and forth in track 344.

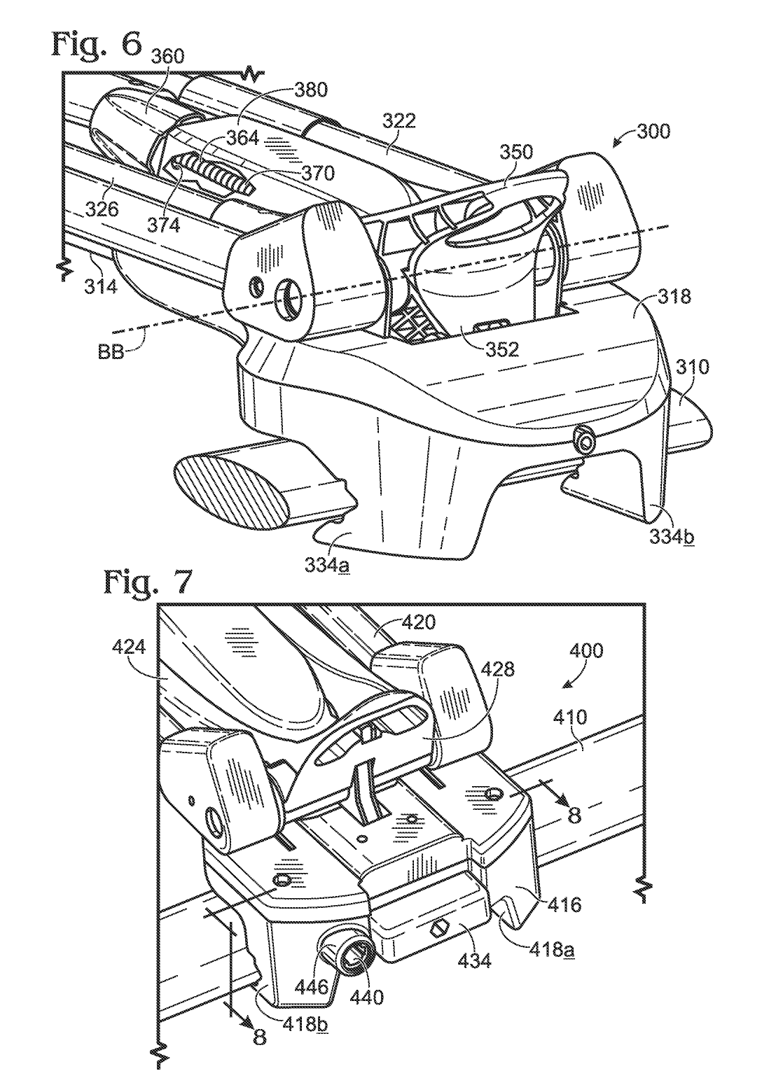

FIG. 6 shows a perspective elevation view of the bike mount shown in FIG. 5. Elongate body 314 includes head 318. Stationary jaws 334a and 334b descend from the bottom side of head 318 for clamping elliptically-shaped crossbar 310. First hoop member 322 and second hoop member 326 are collapsed in their stowed position. Ramp 350 projects upward while lever arm 352 projects downward in a position ready for bicycle loading onto the mount. Knob or handle 360 is provided for tightening second hoop member 326 on the back of a front wheel of a bicycle. As explained previously, after a bike rolls onto ramp 350, second hoop member 326 pivots around axis BB upward into contact with the front wheel of the bicycle. This causes handle 360 to move backwards, thereby moving threads 364 of bolt 370 through aperture 374 of housing 380. When threads 364 are viewable from outside of housing 380, the user may simply spin or tighten knob 360 to secure clamping on the front wheel of the bicycle.

FIG. 7 shows the front portion of bike mount 400 including head 416 having first and second stationary jaws 418a and 418b. First hoop member 420 and second hoop member 424 are shown in their stowed position. Ramp 428 projects upward ready for bicycle loading. Handle 434 is provided for controlling longitudinal sliding movement of a sliding jaw (not shown). It should be appreciated that other tightening mechanisms may be substituted for handle 434. For example, a “quick release” style cam lever type actuator may be used instead. Lock device 440 is provided for locking head 416 onto crossbar 410 as shown and explained in more detail below. A key may be used to rotate a lock cylinder inside port 446 which may selectively obstruct, restrict or block rotation of handle 434.

The sliding jaw or “claw” may be driven by a screw, for example, approximately 5 inches long. At one end of the screw is a knob. To lock the mount to the crossbar, a locking feature may be added to prevent the knob from turning. The locking solution may vary between products. Any solution that prevents the screw from turning may be used to lock the mount to the crossbars.

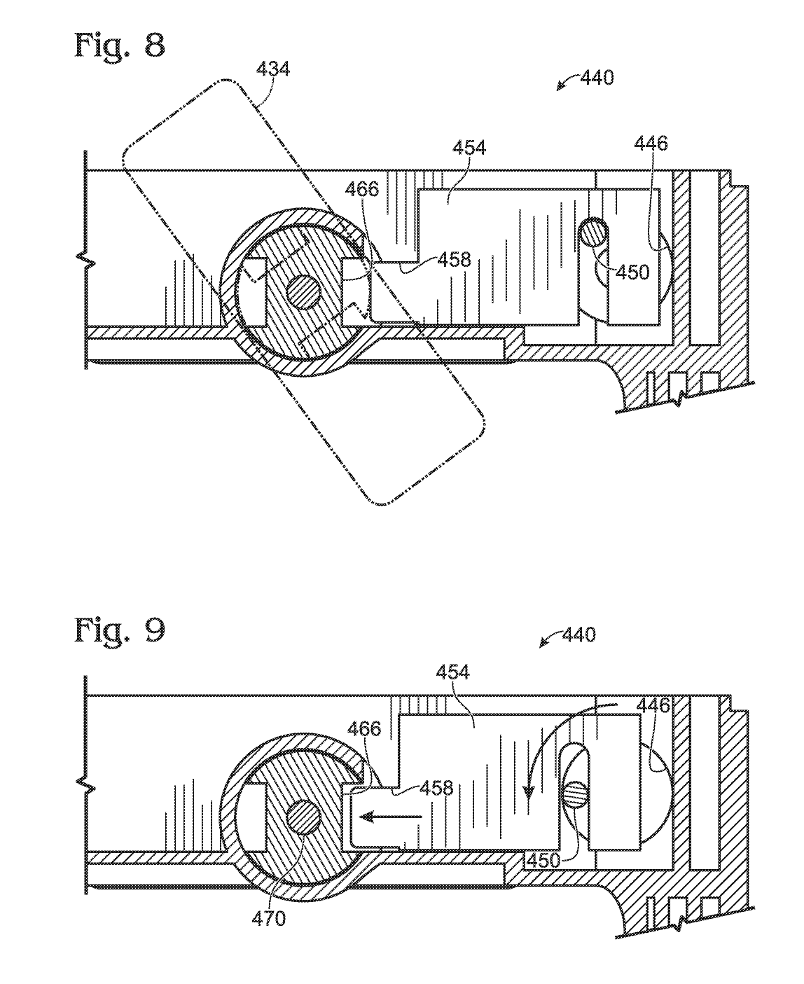

FIGS. 8 and 9 show views inside lock device 440 illustrating an exemplary locking mechanism. Lock device 440 has a key-operated barrel 446. As barrel 446 rotates, pin 450 also rotates counterclockwise as shown from the view in FIG. 8 to the view in FIG. 9. Movement of pin 450 shifts follower 454 to the left of the figures, as shown by the arrow in FIG. 9. Handle 434 is connected to a shaft component which has notches or recesses 456. When follower 454 moves to the left in FIG. 9, projection 458 moves into recess 466, thereby preventing handle 434 from rotating. The position in FIG. 9 prevents shaft 470 from rotating, thereby preventing the bike mount from being removed from the crossbar.

For smaller mounts, for example, such as boat, saddles or a wheelfork, the fixed jaw may be approximately 3-4 inches wide while the sliding jaw may be narrower, for example, 1-2 inches wide. To prevent crossbar damage on a larger mount like an upright bike mount, the load may be spread further apart. The upright bike mount may have a clamp area that is, for example, approximately 8 inches wide. Rather than have two sets of clamps 8 inches apart, the mount may have a pair of fixed jaws with one sliding jaw set between the fixed jaws. With only one center sliding jaw, the mount may be easier to attach to the crossbar.

Each front stationary jaw is about an inch wide. The total span, to the outside, of the two front jaws is at least six inches, or more preferably about seven inches. A wider span is more stable. If the jaw span is smaller, the loads on the crossbar are higher. This may cause small or weaker crossbars to fail. Also a seven inch wide clamp span coincides with a reasonable seven inch span for the width of the front wheel hoop. In a preferred design the space between the front jaws is about 4.75 inches. The gap reduces material, allows the rack to better fit crossbars with a slight crown. Having a gap also allows the mount to straddle or avoid other crossbar mounts, for example, mounting hooks for a fairing.

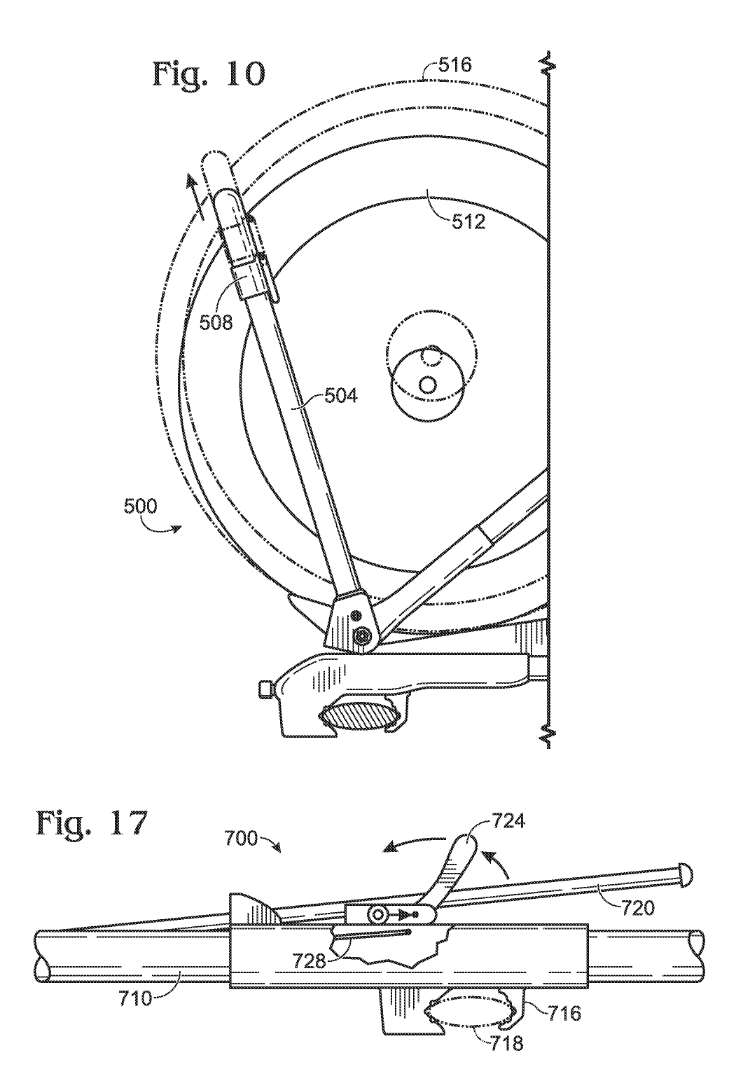

FIG. 10 shows bike mount 500 including first hoop member 504. Hoop member 504 has telescoping adjustment device 508 for altering the size of hoop member 504 to accommodate wheels 512 and 516 of different sizes.

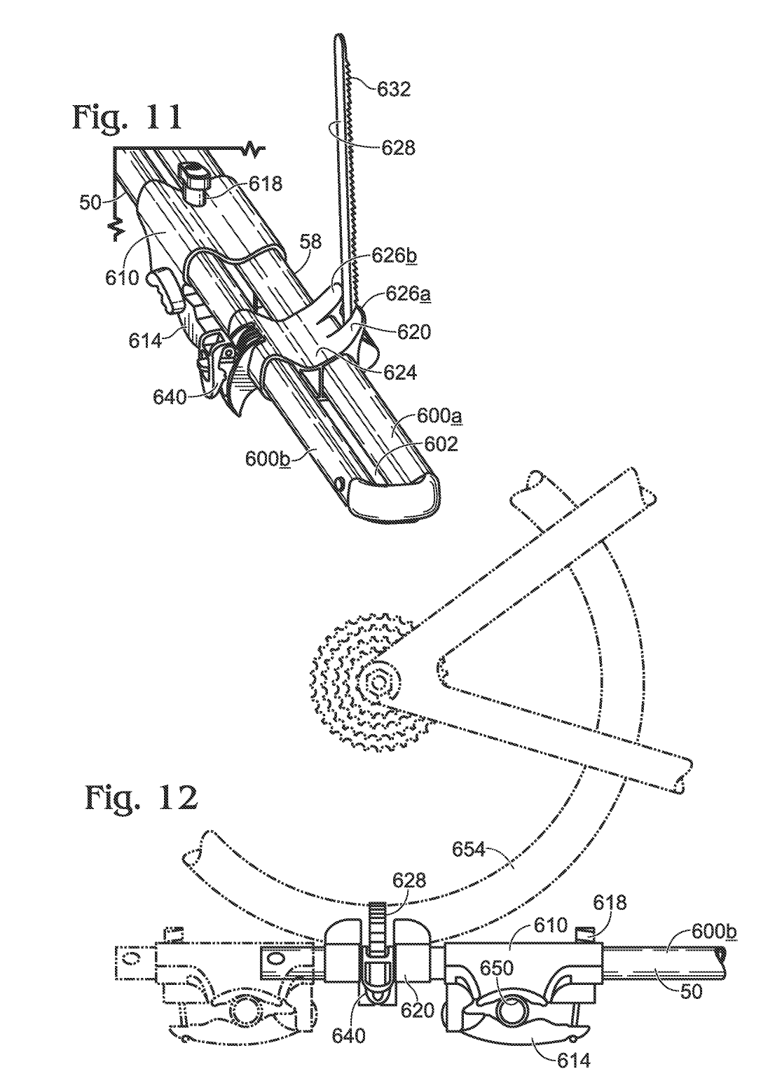

FIG. 11 shows back portion 58 of elongate body 50 of a bike mount, for example, as shown and discussed previously. Body 50 is in the form of a “split-tray” creating a gap, groove, or pocket for supporting a bike wheel. Accordingly, body 50 has parallel elongate beams 600a and 600b. Beams 600a and 600b are preferably made of hollow lightweight metal or plastic construction. Beams 600a and 600b are spaced from each other forming gap 602.

Rear clamp 610 is movable along the length of body 50 for accommodating crossbars in different positions. Clamp 610, as shown, includes bale 614 for contacting the underside of a crossbar, and handle or knob 618 for selectively clamping or unclamping a crossbar. Alternatively, a longitudinal or “horizontal” sliding clamp, such as the ones described above with respect to the front of the bike mount, may be used in the rear as well.

Wheel binding device 620 also may be moved along the length of body 50. Binding device 620 includes a curved “taco” expanse. The taco has ears 626a and 626b defining a slot for strap 628. Strap 628 has teeth 632 for engaging ratcheting actuator 640 on the other side of the taco 624.

FIG. 12 shows a side view of the bike mount shown in FIG. 11. Clamp 610 includes bale 614 for gripping the underside of circular crossbar 650 in response to tightening manipulation of handle 618. Binding device 620 is used to secure strap 628 around wheel 654 using actuator 640.

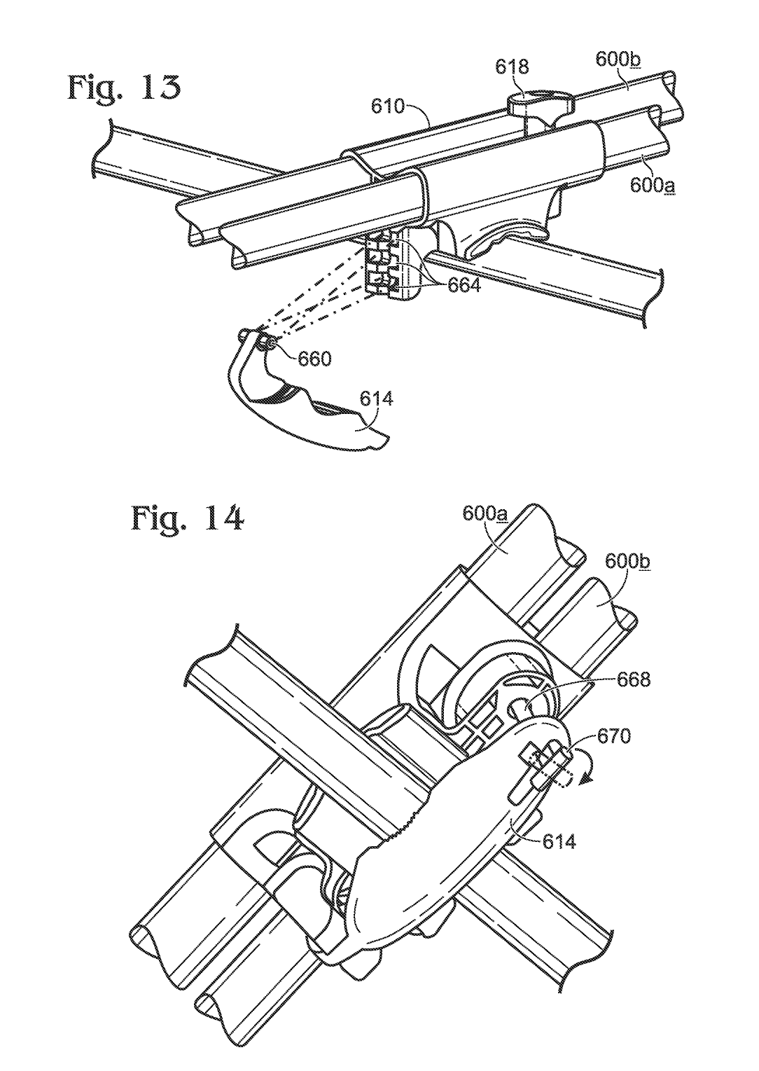

FIGS. 13 and 14 show different views of rear clamp 610. As shown in FIG. 13, bale 614 has pins 660 which selectively engage an appropriate slot 664 for accommodating crossbars of different sizes. FIG. 14 shows a bottom view of rear clamp 610. Handle 618 is connected to bolt 668. Bolt 668 has a t-structure on the bottom end which fits in a slot on the bottom side of bale 614.

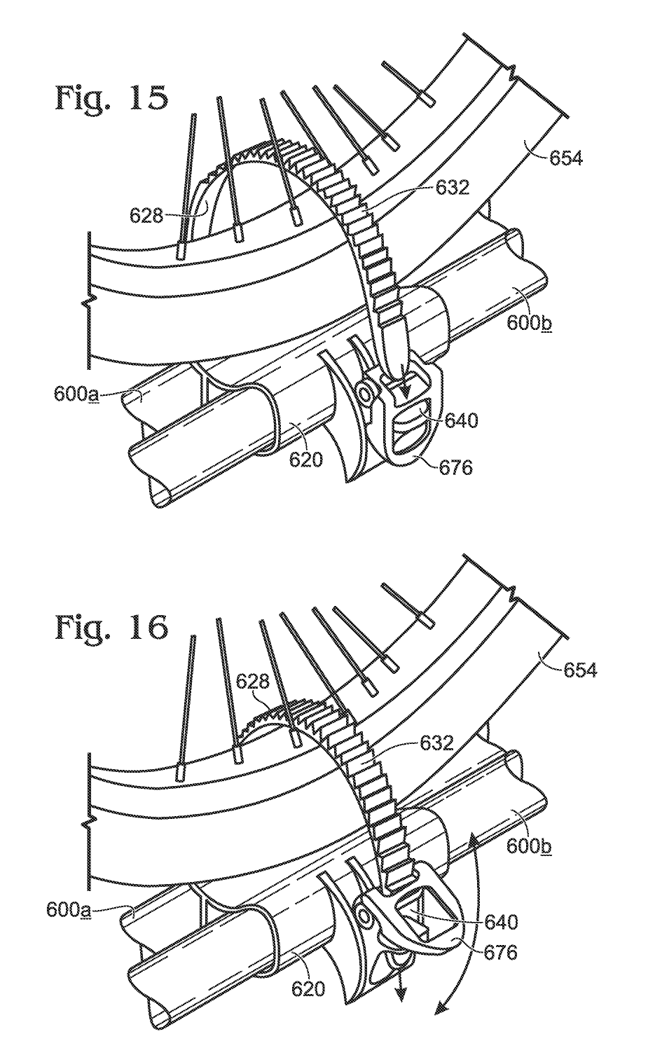

FIGS. 15 and 16 show operation of binding device 620 to secure wheel 654 on the bike mount. In FIG. 15, strap 628 is threaded through actuator 640. In FIG. 16 handle 676 on actuator 640 is used to tighten strap 628 by gripping and pulling teeth 632 through actuator 640.

FIG. 17 shows an alternative bike mount example. Bike mount 700 includes elongate body 710 and clamp 716 for securing the bike mount on crossbar 718. Rear hoop member 720 is provided for securing the front wheel of a bicycle in cooperation with a front hoop member (not shown). Instead of a screw knob for tightening rear hoop member 720, bike mount 700 uses a cam lever (“quick-release”) device 724. As hoop member 720 moves upward (counterclockwise), bolt or rod 728 moves rearward (right in the figure), thus causing cam lever 724 to rotate counterclockwise. Final tightening of hoop member 720 on a bicycle wheel may be achieved by an over-center action of cam lever 724 provided by a suitable cam surface around pivot the point.

The various structural members disclosed herein may be constructed from any suitable material, or combination of materials, such as metal, plastic, nylon, plastic or any other materials with sufficient structural strength to withstand the loads incurred during use. Materials may be selected based on their durability, flexibility, weight, and/or aesthetic qualities.

Although the present disclosure has been provided with reference to the foregoing operational principles and embodiments, it will be apparent to those skilled in the art that various changes in form and detail may be made without departing from the spirit and scope of the disclosure. The present disclosure is intended to embrace all such alternatives, modifications and variances. Where the disclosure recites “a,” “a first,” or “another” element, or the equivalent thereof, it should be interpreted to include one or more such elements, but neither require nor exclude two or more such elements. Further, ordinal indicators, such as first, second, or third for identified elements are used to distinguish between the elements; they do not indicate a required or limited number of such elements, and do not indicate a particular position or order of such elements unless otherwise specifically stated. Any aspect shown or described with reference to a particular embodiment should be interpreted to be compatible with any other embodiment, alternative, modification, or variance.

This disclosure provides examples of devices, methods, and apparatus for carrying cargo on or in connection with a vehicle. Many alternatives and modifications which may or may not be expressly mentioned, are enabled, implied, and accordingly supported by the disclosure and the following claims.

We claim:

1. A bicycle mount for carrying a bicycle on top of a vehicle comprising
an elongate base having a front portion and a back portion,
a front clamp device connected to the front portion of the base configured to clamp a first crossbar on top of a vehicle,
a first hoop structure connected to the front portion of the base, the first hoop structure being pivotal around a first axis between a stowed position generally parallel to the base, and a use position generally upright for cradling a bicycle wheel,
a second hoop structure connected to the front portion of the base, the second hoop structure being pivotal around a second axis between a stowed position generally parallel to the base, and a use position generally upright for cradling a bicycle wheel, the second hoop structure having a ramp member projecting generally upward when the second hoop structure is in the stowed position, and a lever arm projecting downward when the second hoop structure is in the stowed position, the lever arm having a pivot point eccentrically located relative to the second axis,
a bolt member having a first end portion and a second end portion, the first end portion of the bolt member being pivotally connected to the pivot point of the lever arm, the second end portion of the bolt member being threaded and extending through an opening in the base, and
a handle having a hole with internal threads engaging the threaded end portion of the bolt member, the bolt member and handle being configured so threads of the bolt are visibly exposed when the ramp rotates forward causing the bolt to move rearward toward the back portion of the base.

2. The bicycle mount of claim 1 further comprising
a rear clamp connected to the back portion of the base configured to clamp a second crossbar on top of a vehicle.

3. The bicycle mount of claim 1 further comprising
a strap assembly connected to the back portion of the base for securing a bicycle wheel.

4. The bicycle mount of claim 1, wherein the first axis and the second axis are colinear.

5. The bicycle mount of claim 1, wherein the front clamp device includes a fixed jaw and a sliding jaw configured to move on a linear path alternately toward and away from the fixed jaw.

6. The bicycle mount of claim 5, wherein the body has a head portion having an internal track, the sliding jaw being configured for sliding in the internal track.

7. The bicycle mount of claim 5 further comprising a bolt having a threaded portion engaging the sliding jaw, and a handle on the bolt for manipulating the bolt to control sliding movement of the sliding jaw.

8. The bicycle mount of claim 1, wherein the body has a head portion on the front portion, the head portion having two stationary jaws spaced apart from each other descending from a bottom side of the head portion, and a sliding jaw configured for reciprocating movement toward and away from the two stationary jaws.

9. The bicycle mount of claim 8, wherein the body has a long axis, and a sliding jaw sliding on a linear path parallel to the long axis.

10. A bicycle mount for carrying a bicycle on top of a vehicle comprising
an elongate base having a front portion and a back portion,
a front clamp device connected to the front portion of the base configured to clamp a first crossbar on top of a vehicle, the front clamp device including a fixed jaw and a sliding jaw configured to move on a linear path alternately toward and away from the fixed jaw.
a first hoop structure connected to the front portion of the base, the first hoop structure being pivotal around a first axis between a stowed position generally parallel to the base, and a use position generally upright for cradling a bicycle wheel, and
a second hoop structure connected to the front portion of the base, the second hoop structure being pivotal around a second axis between a stowed position generally parallel to the base, and a use position generally upright for cradling a bicycle wheel.

11. The bicycle mount of claim 10 further comprising
a rear clamp connected to the back portion of the base configured to clamp a second crossbar on top of a vehicle.

12. The bicycle mount of claim 10 further comprising
a strap assembly connected to the back portion of the base for securing a bicycle wheel.

13. The bicycle mount of claim 10, wherein the first axis and the second axis are colinear.

14. The bicycle mount of claim 10, wherein the second hoop structure has a ramp member projecting generally upward when the second hoop structure is in the stowed position.

15. The bicycle mount of claim 14, wherein the second hoop structure has a lever arm projecting downward when the second hoop structure is in the stowed position, the lever arm having a pivot point eccentrically located relative to the second axis, and further comprising
a bolt member having a first end portion and a second end portion, the first end portion of the bolt member being pivotally connected to the pivot point of the lever arm, the second end portion of the bolt member being threaded and extending through an opening in the base, and
a handle having a hole with internal threads engaging the threaded end portion of the bolt member, the bolt and handle being configured so threads of the bolt are visibly exposed when the ramp rotates forward causing the bolt to move rearward toward the back portion of the base.

16. The bicycle mount of claim 10, wherein the body has a head portion having an internal track, the sliding jaw being configured for sliding in the internal track.

17. The bicycle mount of claim 10 further comprising a bolt having a threaded portion engaging the sliding jaw, and a handle on the bolt for manipulating the bolt to control sliding movement of the sliding jaw.

18. A bicycle mount for carrying a bicycle comprising
an elongate body having a long axis, a front portion and a rear portion,
a wheel gripping device connected to the front portion of the elongate body,
a wheel cradling device connected to the rear portion of the elongate body, and
a crossbar clamp connected to the front portion of the elongate body, the clamp including a first claw that is moveable along a linear path parallel to the long axis of the elongate body.

19. The bicycle mount of claim 18, wherein the clamp includes a second claw opposing the first claw, and a handle for controlling reciprocating movement of the first claw relative to the second claw.

20. The bicycle mount of claim 19, wherein each claw has a concave internal surface for contacting a crossbar wherein each internal surface has a series of grooves running perpendicular to the long axis of the elongate body.

21. The bicycle mount of claim 19, wherein each claw has a series of three linear recesses running perpendicular to the long axis of the elongate body, for adapting the clamp to crossbars of different shapes and sizes.

22. A bicycle mount for carrying a bicycle comprising
an elongate body having a long axis, a head portion and a rear portion,
a wheel gripping device connected to the front portion of the elongate body,
a wheel cradling device connected to the rear portion of the elongate body, and
wherein the head portion has an end wall, the end wall having a front side and a back side facing the rear portion of the elongate body, a handle accessible from the front side of the end wall, the handle being connected to a first end portion of a shaft that passes through a passage in the end wall, the shaft having a second end portion connected to a sliding jaw, manipulation of the handle permitting linear adjustment of the relative distance between the back side of the end wall and the sliding jaw for gripping a crossbar.

23. The bicycle mount of claim 22, wherein the handle include a hole having threads for engaging the shaft.

24. The bicycle mount of claim 22, wherein the handle includes a knob for rotating the shaft.

25. The bicycle mount of claim 22, wherein the handle includes a lever having a pivot axis perpendicular to the shaft.

26. The bicycle mount of claim 25, wherein the lever has an eccentric outer surface configured to cause movement of the sliding jaw as the lever rotates around the pivot axis.

27. The bicycle mount of claim 22, wherein the shaft has a threads engaging the sliding jaw.

28. The bicycle mount of claim 22, wherein the head portion has a track defining a path parallel to the long axis of the elongate body, the sliding jaw being moveable along the track to adjust the relative distance between the back side of the end wall and the sliding jaw.

29. The bicycle mount of claim 22, wherein each of the back side of the end wall and the sliding jaw has an internal concave surface for contacting a crossbar.

30. The bicycle mount of claim 29, wherein each of the internal concave surfaces has a plurality of linear recesses oriented perpendicular to the long axis of the elongate body.
